(19) United States
(12) Patent Application Publication
(10) Pub. No.: US 2006/0091720 A1
(43) Pub. Date: May 4, 2006

(54) Wheel and a wheel disc

(75) Inventors: Evandro Luis Francischetti, Limeira - SP (BR); Marcelino Marcao, Sao Paulo (BR); Flavio Rodrigues, Sao Paulo (BR)

Correspondence Address: CARLSON, GASKEY & OLDS, P.C., 400 WEST MAPLE ROAD, SUITE 350, BIRMINGHAM, MI, 48009, US

(73) Assignee: Arvinmeritor Do Brasil Sistemas Automotivos LTDA, Limeira - SP (BR)

(21) Appl. No.: 10/527,505

(22) PCT Filed: Sep. 5, 2003
(86) PCT No.: PCT/BR03/00127

§ 371 Date: Aug. 18, 2005

(30) Foreign Application Priority Data
Sep. 12, 2002 (BR) PI0203723-8

(51) Int. Cl. B60B 3/06

(52) U.S. Cl. 301/65

(57) ABSTRACT

A wheel, particularly for use on automotive vehicles, is formed by associating a substantially cylindrical wheel rim and a substantially circular wheel disc to each other. The wheel disc includes at least one through bore having at least one projection that cooperates with the wheel rim.

### REFERENCE TO RELATED APPLICATIONS

This application claims priority to PCT Application PCT/BR2003/000127 filed on Sep. 5, 2003, which claims priority to Brazilian Patent Application PI0203723.8 filed on Sep. 12, 2002.

### DESCRIPTION OF THE PRIOR ART

The present invention relates generally to a wheel, particularly for use on vehicles, which is made from a stamped material and has an esthetic quality similar to that of wheels that are made from light-metal alloys by casting, as well as a disc for use on the wheel.

Wheels designed for use on vehicles, particularly automotive vehicles, may be classified into two main categories according to their manufacture process: wheels made from a stamped material and wheels made from light-metal alloys by casting.

Although the wheels made from a stamped material are easy to manufacture and have a low cost per unit, they have the drawback of not presenting an attractive design. There use is limited to low-cost vehicles or commercial utility/commercial vehicles, for which the esthetic factor is not of great importance. The wheels made from light metal are more flexible with regard to manufacture and variation in design. They are also esthetically more attractive. However, they are expensive, and their price is usually prohibitive for some segments of the automotive market.

The wheels made from a stamped material (usually carbon steel) from the prior art include a substantially cylindrical or truncated-cone-shaped rim and a substantially circular wheel disc ridigly associated to each other, usually by welding. However, screws, rivets, etc. can also be used. The stamped wheels may be subdivided into two types according to their constructive form.

A first type of stamped wheel is formed by a rim having two opposed end regions, or flanges, which define a region where a diameter of the wheel is maximum. The flanges are protuberant, have a substantially curved “┐”-shaped or “J”-shaped profile, and define a groove for fixing a tire. These wheels are called conventional stamped wheels.

A second type of stamped wheel includes a rim having only one wheel flange, and the other flange is an integral part of the wheel disc. Again, the disc flange and the rim flange define a region where the wheel diameter is maximum. Thus, the flange of the disc defines the maximum wheel diameter. These wheels are known as integrated wheels and have the advantage of providing a more attractive and elaborate designs, while keeping the manufacturing cost low.

However, there are some problems associated with the integrated wheels. For example, there is a greater difficulty in achieving symmetry and alignment of the wheel. The design is still inferior to the design of the wheels made from light-metal alloys. There is also a need for greater accuracy in the manufacture, and the price per unit is greater.

Document EP A 0768191 (Porsche A G) discloses a wheel for a motor vehicle including a rim spider with air openings and a rim wheel connected with the rim spider. The wheel includes at least two shell parts (the rim spider and the wheel) that are assembled to form the wheel. Each of the components includes an inner wall and an outer wall. The rim spider and the wheel are connected in the area of air opening, with one forming hollow spokes.

This wheel was developed to be used on high performance vehicles, such are sport cars, and the manufacturing cost is very high. The advantages of this wheel are, mainly, reduced weight due to the existence of the hollow spokes, the aggressive appearance, and the cooling efficiency of the brake system of the vehicle equipp

U.S. Pat. No. 6,234,581 (Porsche A G) and U.S. Pat. No. 6,152,351 (Porsche A G) relate to a wheel and to a process for manufacturing a wheel for a motor vehicle that is very similar to the wheel disclosed in EP A 0768191. Hence, they relate to a wheel to be used on high performance vehicles with a very high manufacturing cost.

### OBJECTIVES OF THE INVENTION

An objective of the present invention is to provide a stamped wheel, particularly for use on automotive vehicles, which is as esthetically attractive to a consumer as a wheel made from light-metal alloys, that is more flexible with regard to the design options than integrated wheels, and that has the same low manufacture cost of the stamped wheels. The process of welding a wheel disc to a wheel rim may be carried out with existing manufacture equipment, demanding little or no investment in purchasing new equipment for the production line.

Another objective of the present invention is to provide a wheel disc for use on the above-described wheel.

### SUMMARY OF THE INVENTION

The objectives of the present invention are achieved by a wheel, particularly for use on automotive vehicles, formed by associating a substantially cylindrical wheel rim and a substantially circular wheel disc to each other. The wheel rim includes at least one flange, and the wheel disc includes at least one through bore having at least one projection which cooperates with the wheel rim and a substantially annular end region that defines a first contact surface. The first contact surface of the wheel disc cooperates with the wheel rim at an end of the flange.

The main advantages of the present invention, among other equally relevant advantages, are the possibility of making feasible a stamped wheel having the benefits of the conventional and integrated stamped wheels (such as the ease of obtaining symmetric and aligned wheels, low manufacture cost per unit, more attractive and more elaborate esthetics). The present invention also presents a wider variety of design options than the integrated wheels and have an appearance equivalent to the appearance of a wheel cast from light-metal alloys.

### DETAILED DESCRIPTION OF THE FIGURES

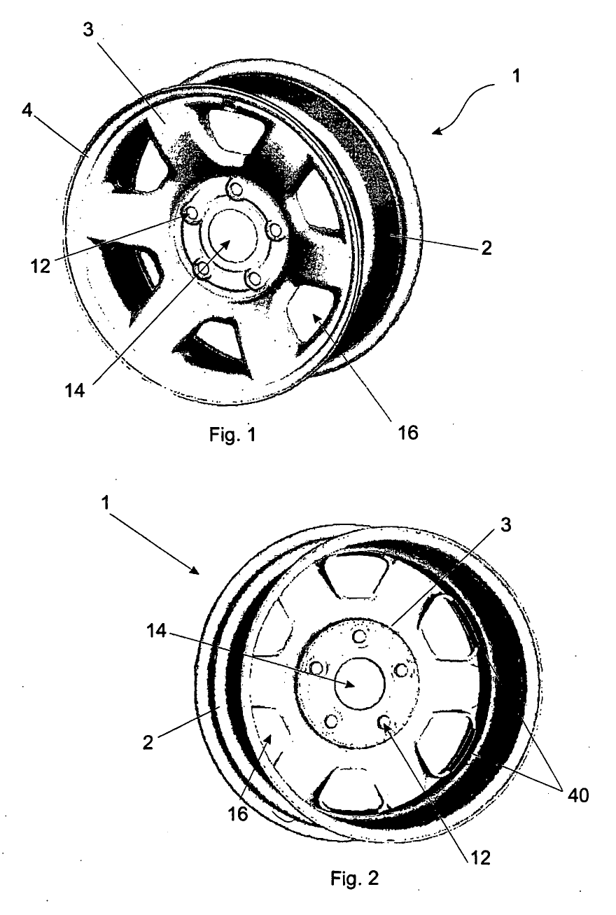

FIG. 1 shows a perspective view of a first constructive variation of a wheel of the present invention;

FIG. 2 shows a perspective back view of the wheel illustrated in FIG. 1;

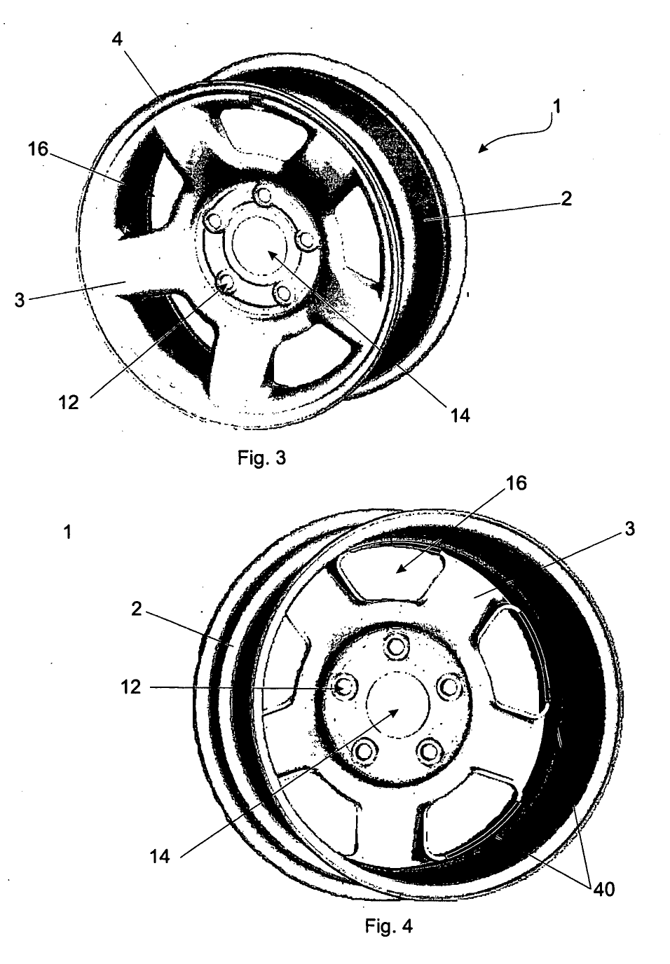

FIG. 3 shows a perspective view of a second constructive variation of the wheel of the present invention;

FIG. 4 shows is a perspective back view of the wheel illustrated in FIG. 3;

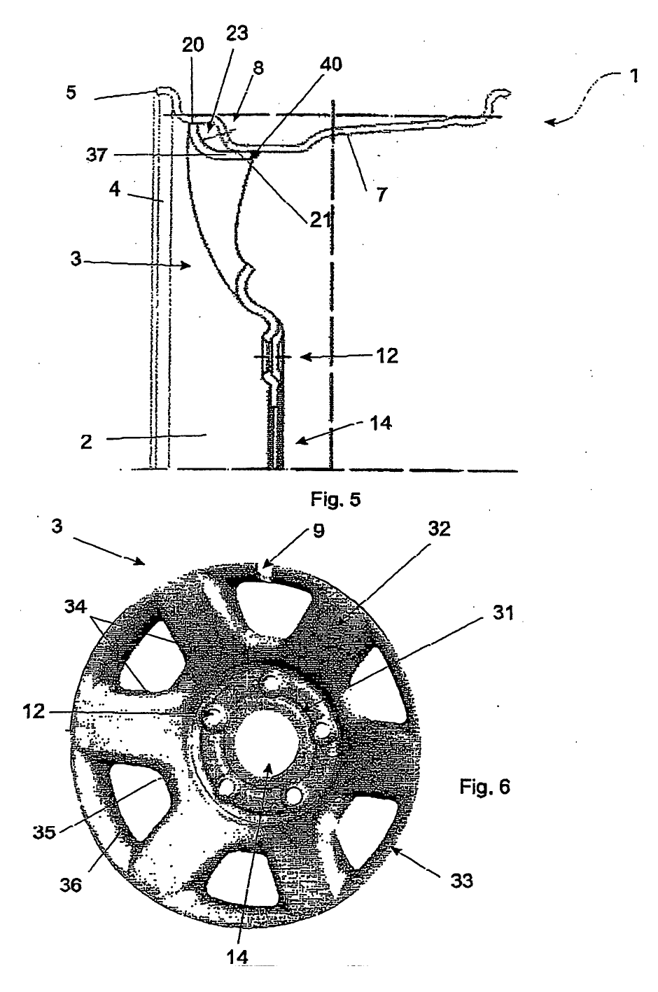

FIG. 5 shows a schematic cross-section view of the wheels illustrated in FIG. 1-4;

FIG. 6 shows a perspective view of a wheel disc of the wheel of the present invention;

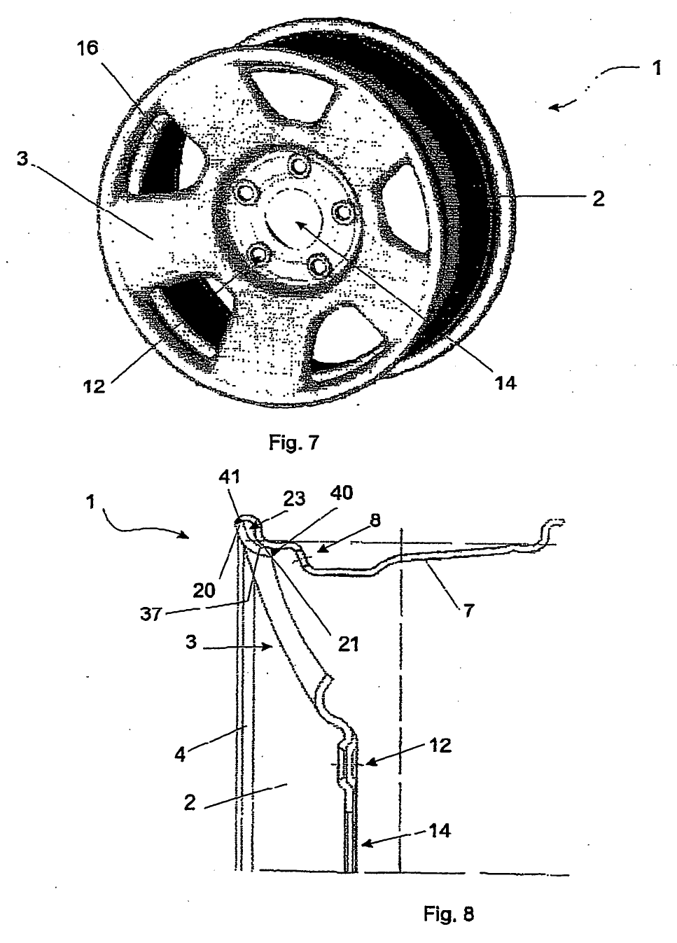

FIG. 7 shows a perspective view of a third constructive variation of the wheel of the present invention; and

FIG. 8 shows a schematic cross-section view of the wheel illustrated in FIG. 7.

### DETAILED DESCRIPTION OF THE PREFERRED EMBODIMENT

According to a preferred embodiment and as shown in FIG. 1, a wheel 1 of the present invention includes a wheel rim 2 associated to a wheel disc 3.

The substantially cylindrical wheel rim 2 is preferably made from carbon steel and has at least two end regions 4, or flanges 4, which constitute the regions where a wheel diameter is maximum. The flanges 4 have a free end 5 projecting substantially perpendicular from the wheel rim 2 that defines a substantially “┐”-shaped or “J”-shaped profile. The flanges 4 define a substantially U-shaped intermediate region 7 that configures a channel for fixing a tire (not shown).

Preferably, a bore 8 is provided for placing a valve to control the inflation of the tire between one of the flanges 4 of the wheel rim 2 and the intermediate region 7, although the bore 8 may also be positioned at any other location in the wheel rim 2 wall.

The wheel disc 3 is substantially circular in shape and is preferably stamped from carbon steel. The wheel disc 3 includes a first central region 31, a second intermediate region 32 and a third external region 33, as shown in FIG. 5.

The first central region 31 is substantially circular and preferably includes a central bore 14 in which a tip of the vehicle axle is accommodated and at least two adjacent bores 12 to fix the wheel 1 to a wheel hub of the vehicle (not shown). Preferably, the wheel 1 is fixed to the wheel hub by screwing.

The second intermediate region 32 is substantially annular and projects from and is concentric with the first central region 31. The second intermediate region 32 includes at least one through bore in the form of a brake-ventilation window 16. Usually, the ventilation windows 16 both ventilate the brakes and improve the esthetic quality of the wheel 1. In the present invention, the ventilation windows 16 have a new additional function that will be explained later.

The third external region 33 projects from the second intermediate region 32 and is annular in shape and concentric with the first central region 31 and the second intermediate region 32 of the wheel disc 3. The third external region 33 defines the end of the wheel disc 3, at which there is a first contact surface 20. The wheel disc 3 is manufactured in such that the first contact surface 20 cooperates with the wheel rim 2 and almost touches or slightly touches the wheel rim 2. This provides the impression that the wheel 1 is a single piece, like the integrated wheels and the wheels made from light-metal alloys.

Preferably, but not compulsorily, the third external region 33 includes a tear 9 which overlaps the bore 8 of the wheel rim 2, allowing a tire-inflation valve (not shown) to pass.

In the preferred embodiment, the ventilation windows 16 are substantially trapezoidal in shape. The ventilation windows 16 include two walls 34 arranged radially with respect to the center of the wheel disc 3. The ventilations windows 16 also include a first wall 35 that is semi-circular and substantially perpendicular to a radius of the wheel disc 3 and located substantially near the first central region 31. The ventilations windows 16 also includes a second wall 36 that is semi-circular and also substantially perpendicular to the radius of the wheel disc 3 and located substantially near the third external region 33.

The second concentric wall 36 includes a projection 37 that faces the internal surface of the wheel disc 3, that is, that faces the wheel hub of the vehicle. The projection 37 defines a second contact surface 21 between the wheel disc 3 and the wheel rim 2. The second contact surface 21 is only present in the ventilation windows 16. Preferably, the projections 37 are substantially in form of an annular segment, but they may have other shapes as long as they are functional.

Evidently, the ventilation windows 16 may have shapes other than the trapezoidal shape described. For example, the ventilation windows 16 can be circular, triangular, hexagonal, etc. However, at least the second wall 36 (or a part of it) that is located in the third external region 33 of the wheel disc 3 has to provide a recess that faces the wheel hub and defines the second contact surface 21 with the wheel rim 2, exactly as described in the preceding paragraph.

As shown in FIGS. 5 and 8, when the wheel rim 2 and the wheel disc 3 are associated, the first contact surface 20 virtually or slightly touches the wheel rim 2 at a point substantially near the flange 4 or, alternatively, at the free end of the flange 4. The second contact surface 21 cooperates with the wheel rim 2, touching it at a point substantially located in the intermediate region 7 of the wheel rim 2. A small cavity 23 is formed between these two contact surfaces 20 and 21, the walls of which are defined by the wheel rim 2 and the wheel disc 3.

In the first and second constructive embodiments of the wheel 1, the fixation of the wheel disc 3 to the wheel rim 2 (which is effected by welding,) occurs only on the second contact surface 21, as shown in FIGS. 2, 4 and 5. Because fixing welding 40 is performed in a back portion of the wheel disc 3 (facing the wheel hub) and because of the configuration of a front surface of the wheel disc 3, which virtually touches the flange 4, the wheel 1 has a more elaborate finishing than the stamped wheels from the prior art. This provides the impression that the wheel 1 is a single piece, that is, provides the impression that the wheel rim 2 and the wheel disc 3 are continuous.

A natural centering between the wheel disc 3 and the wheel rim 2 occurs due to the projections 37 of the second walls 36 of the ventilation windows 16, which touch the wheel rim 2 in a homogeneous way, and due to the first contact surface 20, defined by the third external region 33. Thus, there is no great difficulty in manufacturing a perfectly centered wheel 1. This provides a great advantage over the integrated-type stamped wheels, the perfect centering of which is somewhat difficult to achieve.

In addition, generally, the larger the second concentric wall 36 of the ventilation window 16 (and consequently the projection 37), the fewer the number of ventilation windows 16 in the wheel disc 3. In this way, the second contact surface 21 will be larger and, as a result, the area available for fixing the wheel rim 2 to the wheel disc 3 will be larger. This imparts more strength to the wheel 1, as can be seen from comparing FIGS. 2 and 4.

FIGS. 7 and 8 show a third constructive embodiment of the wheel 1 of the present invention, in which the first contact surface 20 touches the end of the flange 4 of the wheel rim 2. In this embodiment, in addition to the fixing welding 40 on the second contact surface 21 described above, the first contact surface 20 is also fixed to the flange 4 by a filling welding 41. This is possible because of the constructive geometry of the wheel disc 3, allowing the first contact surface 20 to touch the end of the flange 4. Evidently, one may conceive any variations of the wheel disc 3, as long as they will enable the first contact surface 20 or an adjacent region to touch the flange 4.

At least two additional steps in the manufacture of the wheel can be employed. First, a step for welding the first contact surface 20 to the flange 4 of the wheel 1 can be employed. Next, a step for finishing the welding, for instance, by machining, can be employed.

Unlike the fixing welding 40, the filling welding 41, which is part of the finishing steps, improves the appearance and the finish of the wheel 1. This enhances the impression that the wheel 1 is made from light-metal alloys, increasing the strength of the wheel 1, even if in a reduced way.

Moreover, the filling welding 41 can prevent moisture from entering the cavity 10, thus prolonging the useful life of the wheel 1 and preventing possible corrosion problems.

Evidently, filling means 41 other than the welding can be employed. For example, glue, expanded foam, or any other material that has adhesive properties can be employed.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A wheel, particularly for use on automotive vehicles, comprising:
a substantially cylindrical wheel rim including at least one flange having an end; and
a substantially circular wheel disc including at least one through bore, at least one projection that cooperates with the substantially cylindrical wheel rim, and a substantially annular end region that defines a first contact surface,
wherein the first contact surface of the substantially circular wheel disc cooperates with the end of the at least one flange of the substantially cylindrical wheel rim.

2. The wheel according to claim 1, wherein the first contact surface of the substantially circular wheel disc is fixed to the at least one flange of the substantially cylindrical wheel rim by a filling welding.

3. The wheel according to claim 1, wherein the at least one projection faces an internal surface of the substantially circular wheel disc and defines a second contact surface with the substantially cylindrical wheel rim.

4. The wheel according to claim 1, wherein the at least one projection is substantially annular-segment shaped.

5. The wheel according to claim 3, wherein the at least one projection is substantially annular-segment shaped.
